(19) United States
(12) Patent Application Publication
(10) Pub. No.: US 2008/0191553 A1
(43) Pub. Date: Aug. 14, 2008

(54) SEMICONDUCTOR INTEGRATED CIRCUIT

(75) Inventor: Kazuhiro KAWAMURA, Tokyo (JP)

Correspondence Address: RABIN & Berdo, PC, 1101 14TH STREET, NW, SUITE 500, WASHINGTON, DC, 20005, US

(73) Assignee: Fuji Electric Device Technology Co., Ltd, Tokyo (JP)

(21) Appl. No.: 12/016,579

(22) Filed: Jan. 18, 2008

(30) Foreign Application Priority Data
Jan. 18, 2007 (JP) 2007-009487

(51) Int. Cl. H02J 1/00; H02J 3/14

(52) U.S. Cl. 307/31

(57) ABSTRACT

A semiconductor integrated circuit for driving a display such as a plasma display has a plurality of output bit circuits each including a latch circuit, a comparator circuit comparing the state of the latch circuit output for its own output bit circuit with the state of the latch circuit output for adjacent output bit circuits on both sides and also comparing the result of this comparison with the result of a comparison for the next inputted data, and a storage circuit holding these results. When the comparator circuit detects that the states of the outputs of all three output bit circuits are continuously the same, the output rise or fall is controlled by output transistors so as to be slow. This enables the output state transition to have a specified time duration regardless of the magnitude of the load, to reduce electromagnetic noise.

### BACKGROUND OF THE INVENTION

1. Field of the Invention

The present invention relates to a semiconductor integrated circuit that outputs voltages from a plurality of output terminals to their respective loads, and more particularly to a semiconductor integrated circuit suited for driving a capacitive load such as a display panel presented at each of the output terminals and, in addition to this, a capacitive load presented between each of the output terminals and each of adjacent output terminals on both sides. The invention is particularly applicable to an address driver IC of a plasma display panel.

2. Description of the Related Art

For a display panel such as a plasma display panel, which emits light by electric discharge of a plurality of discharge cells arranged in a matrix, a driving circuit is used that has a plurality of output terminals for driving the discharge cells through a plurality of electrodes arranged in the row and column directions. It is known that the load at each of the output terminals of the driving circuit is a capacitive load that generates electromagnetic noise when switching transistors in the circuit are driven on and off, and this noise can be suppressed to a minimum by a current limiting device that slows the level transition of the driving pulse outputted from the output buffer (see JP-A-2002-244614, for example). JP-A-2002-244614 further describes selecting the current limiting device depending on the magnitude of the capacitive load. Moreover, for example in JP-A-11-98000, it is proposed that switching noise generation be reduced by transiently clamping the gate-source voltage of an output buffer transistor at a constant voltage. Further, JP-T-2004-514177 (corresponding to U.S. Pat. No. 7,122,968 B2), for example, proposes providing a capacitor for clamping the gate-source voltage of the above transistor at a constant voltage.

FIG. 4 is a diagram showing the configuration of a semiconductor integrated circuit configured as a panel driving circuit having such capacitive loads made up of load capacitances and inter-electrode-line capacitances. The semiconductor integrated circuit includes a plurality of output bit circuits each having an output terminal, although only four of the output bit circuits are shown in FIG. 4. In FIG. 4, the integrated circuit has latch circuits LT101 to LT104, buffer circuits B101 to B104, and level shift circuits LS101 to LS104. The latch circuits LT101 to LT104 latch their respective data DATA101 to DATA104, each transmitted from a shift register, not shown, by an STB signal (strobe signal). Moreover, P-channel transistor P101 and N-channel transistor N101 are connected to each other at their respective drains. Driving pulses are supplied from the connection point to an output terminal (output 101) connected to an electrode line capacitance C101. The same is true for the connection point of P-channel transistor P102 and N-channel transistor N102, the connection point of P-channel transistor P103 and N-channel transistor N103, and the connection point of P-channel transistor P104 and N-channel transistor N104, and driving pulses are supplied to output terminals (output 102, output 103 and output 104) connected to electrode line capacitances C102, C103 and C104, respectively. Furthermore, C112, C123 and C134 designate the inter-electrode-line capacitance for the output 101 and the output 102, the inter-electrode-line capacitance for the output 102 and the output 103, and the inter-electrode-line capacitance for the output 103 and the output 104, respectively. Here ‘inter-electrode-line capacitance’ means a capacitance that is present between the adjacent lines leading to the output terminals.

The number of output bit circuits for outputting the driving pulses from the output terminals in the above circuit can range between tens and hundreds. For each of the output bit circuits, the output terminal is fixed at a high electric potential or at GND (ground) potential. When driving a panel such as a plasma display panel, there are electrode line capacitances of C101 to C104 between the respective output terminals and GND (ground). In addition to this, there are inter-electrode-line capacitances C112, C123 and C134 between the output terminals and their respective adjacent terminals. The driving circuit further contains H side (high side) FETs (transistors P101 to P104), the level shift circuits LS101 to LS104 and L side (low side) FETs (transistors N101 to N104). The H side FET is for fixing an output at a high voltage at each of the output terminals, the level shift circuit is for operating the H side FET, and the L side FET is for fixing the output at the ground (GND) potential. The driving circuit is further provided with the above buffer circuits B101 to B104 for controlling the FETs P101 to P104 and the FETs N101 to N104, respectively, and the latch circuits LT101 to LT 104 for holding data determining the states of output 101 to output 104, respectively. Each of the output 101 to output 104 is outputted as a voltage with the timing of the STB signal (here, at the rising or leading edge) and with a waveform matching the state of the data determined at that time (see FIG. 5B discussed later).

FIG. 5A is a diagram showing the detailed configuration of the circuit of one output bit circuit in the semiconductor integrated circuit described above, and FIG. 5B is a diagram showing the waveforms of the STB signal, the data DATA1 and the output in the circuit shown in FIG. 5A. As shown in FIG. 5A, when the data DATA1 determining the state of an output is transferred to an input bit of the above shift register, the data is transmitted to the latch circuit LT101 by the STB signal. The signal from the latch circuit LT101 is transmitted to a high breakdown voltage section through the buffer circuit B101 including inverters IV101 to IV107 to determine the state of an output.

In the high breakdown voltage section, a level shift circuit LS101 is presented which includes P-channel transistors P203 and P204 and N-channel transistors N203 and N204. The output of the level shift circuit LS101 is determined by a logic signal that is inputted to the gate of P-channel transistor P202 to turn transistor P202 ON and OFF. The drain of transistor P202 is connected to the drain of N-channel transistor N202 to form a high breakdown voltage inverter circuit with transistors P202 and N202. The gate of transistor N202 is connected to the buffer circuit so that transistor N202 is turned ON and OFF by a logic signal. The drains of transistors P202 and N202, being connected to each other, are further connected to the gate of transistor P101. The drain of transistor P101 is connected to the drain of transistor N101 which is turned ON and OFF through the gate thereof by the buffer circuit. The output of the IC (integrated circuit) is obtained from the connection point of the drains of transistors P101 and N 101.

The operation of the circuit is carried out as shown in FIG. 5B in that, when DATA1 from the shift register is at an H (high) level, DATA1 is held in the latch circuit LT 101 at the falling of the STB signal to be outputted as the output signal of the latch circuit LT101 at the H level. The output signal is transmitted to the high breakdown voltage section through inverters IV101 and IV102 in the buffer circuit so that transistor P202 is turned OFF through the level shift circuit. The output signal is also transmitted to transistor N202 through inverters IV103 and IV104 in the buffer circuit to make transistor N202 turn ON. This causes the gate of output stage transistor P101 to be at an L level so that transistor P101 is turned ON. Furthermore, the output signal of the latch circuit LT101 is inverted by inverters IV105, IV106 and IV107 in the buffer circuit to a signal at an L level, which is transmitted to the gate of output stage transistor N101 so that transistor N101 is turned OFF. Hence, the output of the circuit goes to the H level (a high voltage).

Also, in the case where DATA1 from the shift register is at the L (low) level, DATA1 is held in the latch circuit LT 101 at the falling edge of the STB signal. Thus, the latch circuit LT101 outputs a signal at the L level. The output signal is transmitted to the high breakdown voltage section through inverters IV101 and IV102 in the buffer circuit so that transistor P202 is turned ON through the level shift circuit. The output signal is also transmitted to transistor N202 through inverters IV103 and IV104 in the buffer circuit so that transistor N202 is turned OFF. This causes the gate of output stage transistor P101 to be at the H level so that transistor P101 is turned OFF. Furthermore, the output signal of the latch circuit LT101 is converted by inverters IV105, IV106 and IV107 in the buffer circuit to a signal at the H level which is transmitted to the gate of output stage transistor N101 so that transistor N101 is turned ON. Hence, the output of the circuit goes to the L (GND) level.

In the semiconductor integrated circuit as described above, when a capacitive load is also presented between output terminals adjacent to each other, the following problem occurs. FIG. 6 is a diagram showing an example of each of waveforms of outputs outputted from output terminals of their respective output bit circuits. The number of inter-electrode-line capacitances that the output of a certain output bit circuit must charge or discharge varies depending on the difference in waveform between the output of the output bit circuit and the output of each of adjacent output bit circuits on either side. For example, when the levels of three outputs (output 101 to output 103) are at first at the L level and only the level of output 102 is then brought to the H level while the levels of output 101 and output 103 remain at the L level, output 102 must charge not only the electrode line capacitance C102 but also the inter-electrode-line capacitances C112 and C123 simultaneously. Then, when the level of output 102 is changed to the L level, output 102 must simultaneously discharge not only the electrode line capacitance C102 but also the inter-electrode-line capacitances C112 and C123. Then, when the levels of output 101 to output 103 are simultaneously brought to the H level, it is only necessary for output 102 to charge the electrode line capacitance C102.

Subsequent to this, when the levels of output 101 and output 102 are brought to the L level from the foregoing state, output 102 must discharge the electrode line capacitance C102 and charge the inter-electrode-line capacitance C123. Following this, when the levels of output 101 and output 102 are simultaneously changed to the H level, output 102 must charge the electrode line capacitance C102 and discharge the inter-electrode-line capacitance C123. Concerning the capacitor signs drawn under the waveform shown in FIG. 6, capacitors having oblique hatching show capacitors that need to be charged or discharged by change of waveform.

In this way, for a certain output bit circuit (here, the output bit circuit outputting output 102), the number of load capacitances that must be charged or discharged varies depending on the state of the output of its own output bit circuit (here, output 102) and the states of the outputs of the output bit circuits on either side (here, output 101 and output 103). In actuality, the number of charged or discharged load capacitances varies in a slightly more complicated way. FIG. 7 is a view showing characteristic patterns of the states of the load capacitances varying depending on the states of the outputs of the three output bit circuits. The patterns A to D shown in the diagram are those when the state of the output of one output bit circuit (output 102) varies from the L level to the H level, while the adjacent outputs either vary from the L level to the H level or stay at the H level. A partial circuit schematic is shown to the left of each pattern, with each waveform shown next to the respective output.

Pattern A is the case in which all of the levels of output 101 to output 103 rise to the H level from the L level. In this case, it is necessary only that output 102 charges the electrode line capacitance C102. Pattern B is the case in which the state where the levels of output 101 and output 102 are at the L level and the level of output 103 is at the H level changes to the state where the levels of all of the outputs are at the H level. In this case, output 102 must charge the electrode line capacitance C102 and the inter-electrode-line capacitance C123. Pattern C is the case where the relation between the levels of output 101 and output 103 is reversed with respect to pattern B. Also in this case, as in pattern B, output 102 must charge the electrode line capacitance C102 and the inter-electrode-line capacitance C112. Pattern D is the case where the state in which the levels of output 101 and output 103 are at the H level and the level of output 102 is at the L level is changed therefrom to the state where the levels of all of the outputs are at the H level. In this case, output 102 must charge each of the electrode line capacitance C102 and the inter-electrode-line capacitances C112 and C123.

All of the patterns A to D are those in which the levels of the outputs of the adjacent output bit circuits on both sides are brought to the H level together with the level of the output of its own output bit circuit (output 102). However, the number of load capacitances that its own output bit circuit must charge or discharge also relates to the state of the output of the next data. Although the examples show the cases in each of which the levels of the outputs were changed from the L level to the H level, there is also the case in which the levels of the outputs change from the H level to the L level. Therefore, the number of load capacitances that the output of its own output bit circuit must charge or discharge varies depending on the condition of the continuous variation between the state of the output of each of the output bit circuits, its own output bit circuit and the adjacent output bit circuits on either side, for a certain data and the state of the output of each of the output bit circuits for the next data. Thus, the number of combinations of possible variations becomes significant when all the above is taken into account.

FIG. 8 is a view showing the changes of state of the outputs of its own output bit circuit and the adjacent output bit circuits on either side, for the cases in which the load of its own output bit circuit becomes heaviest due to the capacitive loads. FIG. 8 shows both the case in which the level of the output of its own output bit circuit changes from the L level to the H level and the case in which the level of the output of its own output bit circuit changes from the H level to the L level. In both of these cases, the levels of the outputs of the adjacent output bit circuits on either side of its own output bit circuit simultaneously change in the reverse direction to the change in the level of the output of its own output bit circuit. In each of these cases, the pattern of the states of the load capacitances is presented as that with which the output of its own output bit circuit charges the electrode line capacitance C102 and the inter-electrode-line capacitances C112 and the C123. The states of the load capacitances seem to be the same as those in pattern D shown in FIG. 7. Actually, however, with the levels of the outputs of the adjacent output bit circuits on either side of its own output bit circuit simultaneously changed in the reverse direction to the change in the level of the output of its own output bit circuit, the capacitive loads become considerably heavier than those in pattern D. Thus, as described above, there are a considerable number of combinations of changes in the levels of the outputs of the three output bit circuits and the capacitive loads.

FIG. 9 is a waveform diagram showing the states of rising and falling of the output in each of the cases when the capacitive load of the panel is light or heavy for each of the cases where the current capacity of the output stage transistor is and is not suppressed. Normally, when the capacitive load is light, the output speed rises and falls rapidly. Conversely, when the capacitive load becomes heavy, the output speed rises and falls more slowly. Moreover, when the capacitive load is light, abrupt rising and falling of the output level is liable to generate electromagnetic noise. Thus, the idea occurs of suppressing the output stage transistor current capacity so that the output level of transistor cannot change too rapidly even when the capacitive load is light. However, as shown in the lower section in FIG. 9, an excessively suppressed transistor current capacity sometimes causes the rates of rising and falling to become excessively slow when the capacitive load is heavy, which makes the control of suppression difficult.

At the same time, there is a standard that requires the level transition to be completed within a certain specified time for both the rise time and the fall time of the outputted pulse waveform. Therefore, even if the rising speed and the falling speed of the output are slowed to suppress electromagnetic noise such as EMI (electromagnetic interference) when the capacitive load is light, the speeds must be adjusted by taking into consideration that the rising speed and the falling speed are too slow when the capacitive load is heavy. In addition, the rising speed and the falling speed must be determined so as not to become excessively slow when taking into consideration variations in component parts.

Thus, what is required is the realization of an output with the rising speed and the falling speed thereof being independent of the capacitive load. For that, the output must be controlled according to the charged or discharged states of the capacitive loads, which are of four or more kinds according to the combinations with the outputs of its own output bit circuit and the adjacent output bit circuits on either side and the state of their outputs for the next data. Furthermore, the output must be controlled for all of the states with the outputs of its own output bit circuit and the adjacent output bit circuits on either side rising or falling.

In the circuit shown in FIG. 4, however, no outputs can be controlled according to varying loads. Moreover, although JP-A-11-98000 describes that a current limiting device is selected depending on the magnitude of the capacitive load, no specific arrangement for that is described.

Furthermore, the proposal made in JP-T-2004-514177 (corresponding to U.S. Pat. No. 7,122,968 B2) is that an output be controlled depending on an estimated value of the capacitive load obtained from the data indicating that its own output bit circuit and the adjacent output bit circuits on either side are selected or not selected. In the specific embodiment thereof, however, the control is carried out only based upon the present output states of its own output bit circuit and the adjacent output bit circuits on either side without taking into account further output states including those for the next data. In this embodiment, with control based only on the present output states of its own output bit circuit and the adjacent output bit circuits on either side, it is difficult to control the output according to all of the states of the load. Thus, with the previously explained patterns A to D taken into consideration, it is to be said that this method of controlling the output cannot cope with varying conditions of the load at all. Furthermore, a significantly large area is required for forming for each of the output bit circuits a control circuit that operates base upon the output states of the present data and the next data in its own output bit circuit and the adjacent output bit circuits on either side according to the variations of four or more kinds of capacitive loads at each of the rising and the falling edges of the output, and that charges and discharges the load capacitances in a specified time without depending on the states of the capacitive loads. Thus, the realization of such a circuit is impossible in a driver IC containing tens or hundreds of output bit circuits.

### SUMMARY OF THE INVENTION

The invention was made in view of such points for detecting only the state with the lightest load that causes the largest problem from the viewpoint of electromagnetic wave generation. The object of the invention is to provide a semiconductor integrated circuit that carries out control so that the transition of the state of an output is slowed down only when the load is the lightest while reducing generation of electromagnetic noise.

In a preferred embodiment of the invention, in order to solve the above problem, a semiconductor integrated circuit is provided with a plurality of output bit circuits connected to their respective loads. Each of the output bit circuits includes an output terminal connected to the load, an output stage transistor, the transistor being connected to the output terminal and controlled by data inputted to the output bit circuit, a latch circuit taking in the data inputted to the output bit circuit, a first comparator circuit carrying out a comparison of the state of the output of the latch circuit in its own output bit circuit with the state of the output of the latch circuit in each of adjacent output bit circuits on either sides of its own output bit circuit, a storage circuit holding the result of the comparison carried out by the first comparator circuit, and a second comparator circuit carrying out a comparison of the result of the comparison held by the storage circuit with the result of the comparison carried out by the first comparator circuit for the next inputted data. Moreover, when the second comparator circuit detects that the states of the outputs of three adjacent output bit circuits, being its own output bit circuit and the adjacent output bit circuits on either side are continuously mutually the same, at least one of the rising and the falling edge of the output by the output stage transistor is controlled.

According to such a semiconductor integrated circuit, when the circuit detects that the states of the outputs of its own output bit circuit and the two output bit circuits adjacent thereto are mutually the same continuously, the rising or the falling in the output by the output stage transistors is controlled. Therefore, generation of electromagnetic noise can be reduced using a simple arrangement.

The semiconductor integrated circuit according to the invention, when detecting that the states of the outputs of its own output bit circuit and the two output bit circuits adjacent thereto are continuously mutually the same, controls the rising or the falling in the output by the output stage transistors. Therefore, the circuit has the advantage of being able to reduce generation of electromagnetic noise using a simple arrangement.

### BRIEF DESCRIPTION OF THE DRAWINGS

FIG. 1 is a diagram showing the configuration of the semiconductor integrated circuit according to a preferred embodiment of the invention together with load capacitances and inter-electrode-line capacitances.

FIG. 2 is a diagram showing a detailed configuration for one output bit circuit in the semiconductor integrated circuit of the preferred embodiment of FIG. 1.

FIG. 3 is a diagram showing the operation of the semiconductor integrated circuit according to the preferred embodiment of FIG. 1 with output waveforms at specified points in the circuit.

FIG. 4 is a diagram showing the configuration of a prior art semiconductor integrated circuit together with load capacitances and inter-electrode-line capacitances.

FIG. 5A is a diagram showing the detailed configuration of the circuit of FIG. 4 for one output bit circuit.

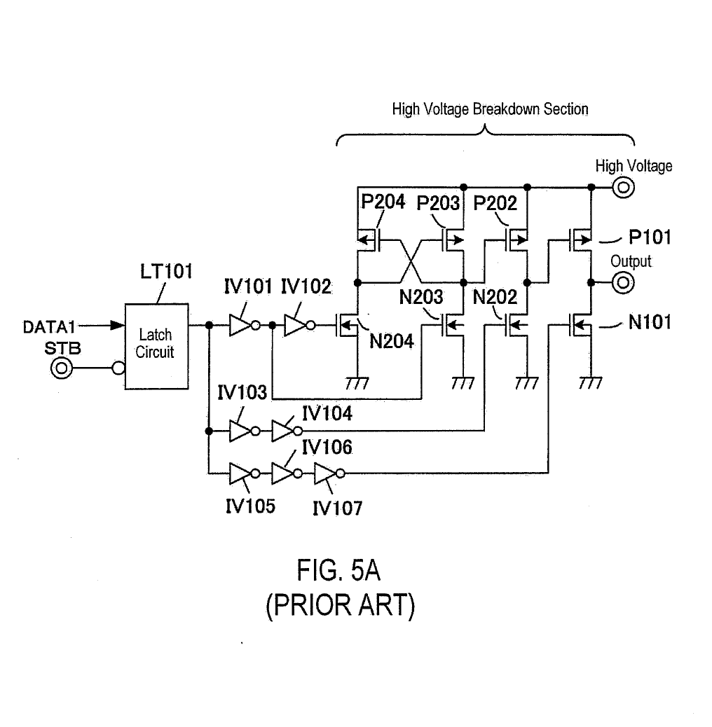

FIG. 5B is a diagram showing the waveforms of the STB signal, the data DATA1 and the output in the circuit shown in FIG. 5A.

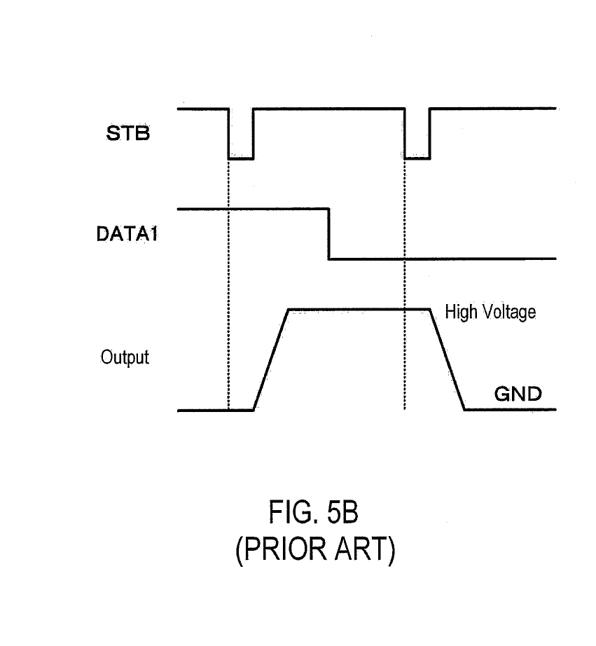

FIG. 6 is a diagram showing an example of each of the waveforms of outputs outputted from output terminals of their respective output bit circuits.

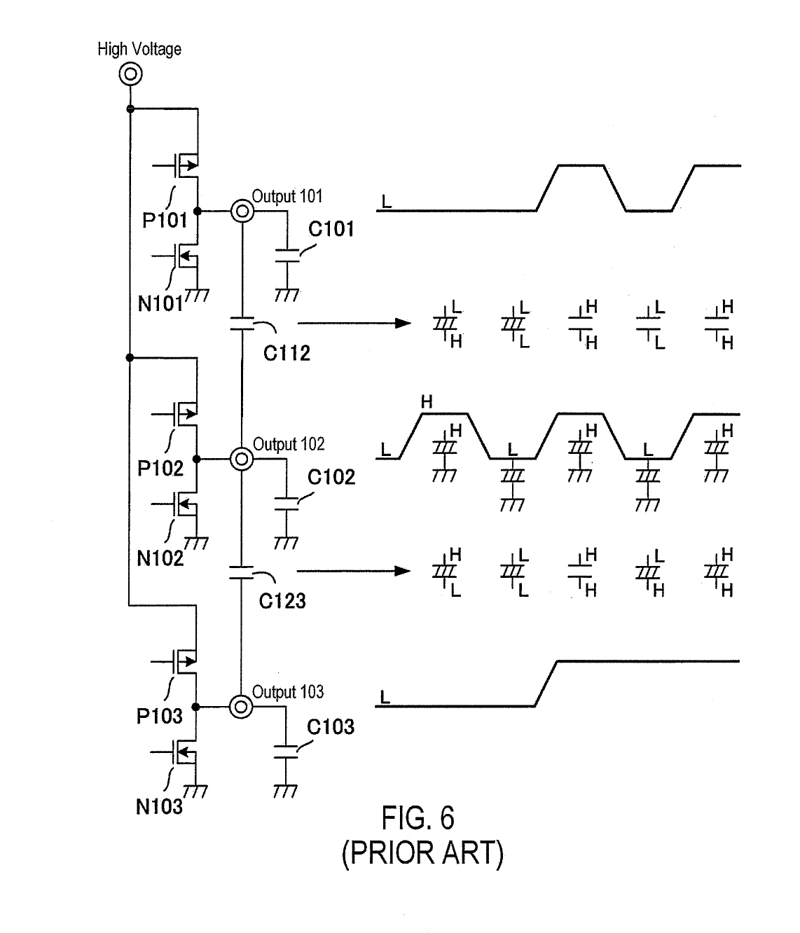

FIG. 7 is a view showing characteristic patterns of the states of the load capacitances varying depending on the states of the outputs of three output bit circuits.

FIG. 8 is a view showing the states of the outputs of its own output bit circuit and the adjacent output bit circuits on either side, in the states for which the load of its own output bit circuit due to the capacitive loads becomes heaviest.

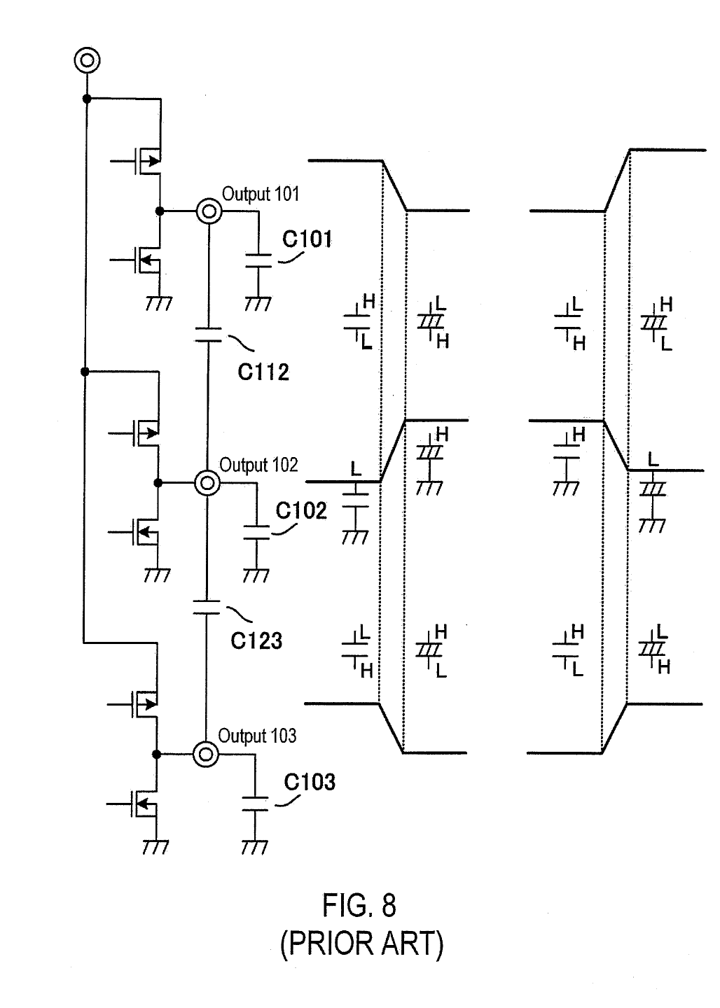

FIG. 9 is a waveform diagram showing the states of rising and falling of the output in each of the cases when the capacitive load of the panel is light and when the capacitive load of the panel is heavy together with the equivalent states when the current capacity of the output stage transistor is suppressed.

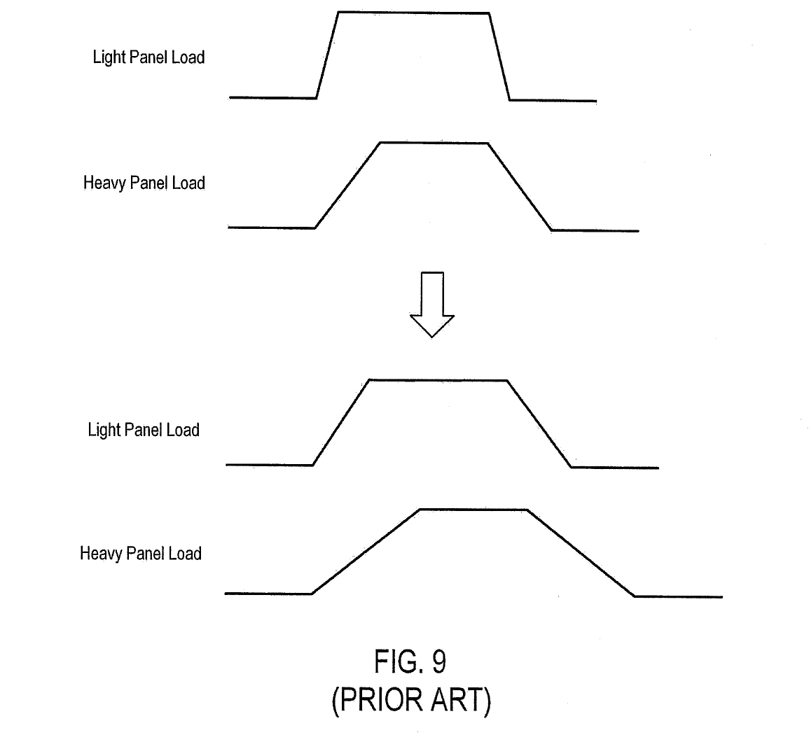

### DESCRIPTION OF THE PREFERRED EMBODIMENTS

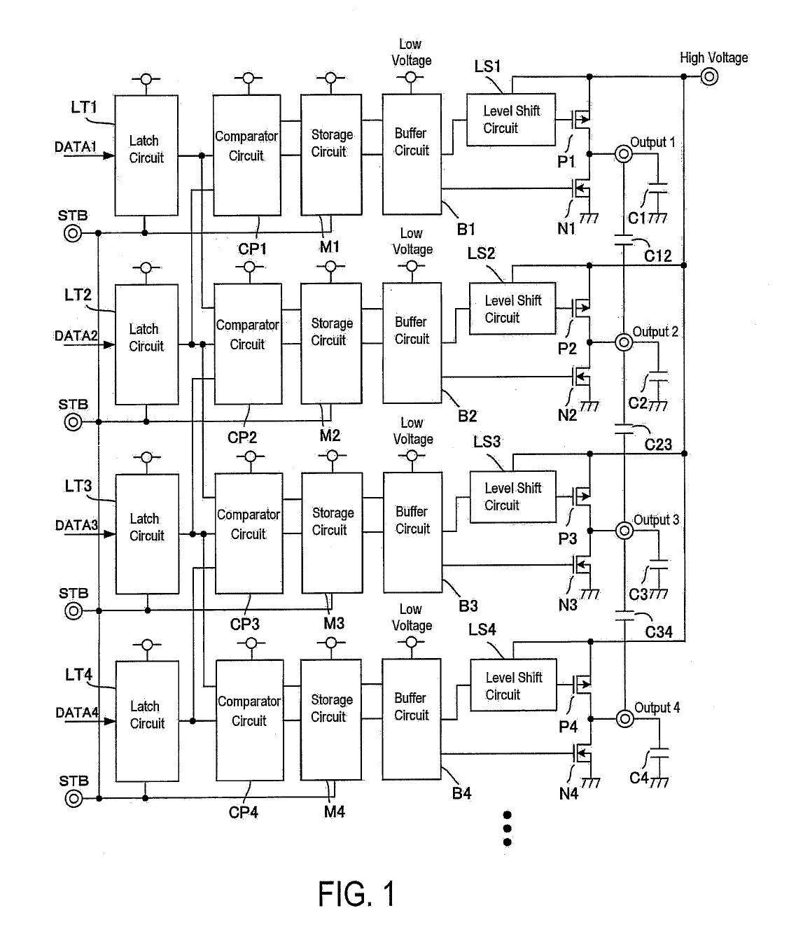

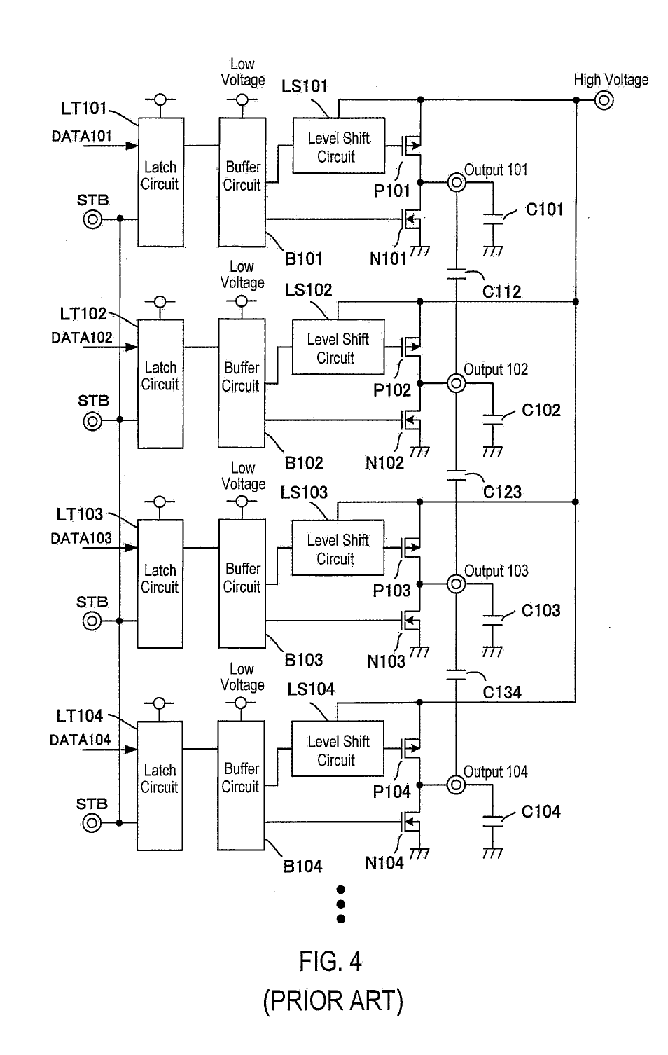

In the following description, a preferred embodiment of the invention will be explained with reference to the drawings. FIG. 1 is a diagram showing the configuration of the semiconductor integrated circuit according to an embodiment of the invention together with load capacitances and inter-electrode-line capacitances. In FIG. 1, as in the prior art circuit shown in FIG. 4, the example shown is employed as a driving circuit for driving a display panel such as a plasma display panel, but the scope of the invention is not limited thereto. The semiconductor integrated circuit has a plurality of output bit circuits each having an output terminal outputting a relatively high voltage. As in the circuit shown in FIG. 4, only four of a plurality of output bit circuits are shown in FIG. 1. The load of each of the output terminals is a capacitive load and a capacitive load is also presented between output terminals adjacent to each other.

In FIG. 1, signs LT1 to LT 4 designate latch circuits latching their respective data (DATA 1 to DATA 4), transmitted from shift registers, not shown, by STB signals. Outputs based on the data latched in the latch circuits LT1 to LT4 are simultaneously outputted from the output terminals of their respective output bit circuits. CP1 to CP 4 designate comparator circuits carrying out comparisons on the data latched in the latch circuits LT1 to LT4, respectively. Each of the comparator circuits CP1 to CP 4 in turn includes a first comparator circuit and a second comparator circuit. The first comparator circuit makes a comparison between the present data of adjacent output bit circuits on either side and the present data of its own output bit circuit, i.e. its own output bit circuit. The second comparator circuit makes a comparison between the result of the comparison made between the next data at the first comparator circuit and the result of the comparison made between the present data at the first comparator circuit. M1 to M4 designate storage circuits each storing the result of the comparison made between the present data and the result of the comparison made between the next data. B1 to B4 designate buffer circuits for driving N-channel transistors N1 to N4, respectively, and signs LS1 to LS4 designate level shift circuits for further driving P-channel transistors P1 to P4, respectively. The drains of the P-channel transistors P1 to P4 are connected to the drains of the N-channel transistors N1 to N4, respectively. From the connection points of the drains, driving pulses of output 1 to output 4 are supplied to electrode line capacitances C1 to C4 respectively. C12, C23 and C34 designate the inter-electrode-line capacitances of outputs 1 and 2, outputs 2 and 3 and outputs 3 and 4, respectively.

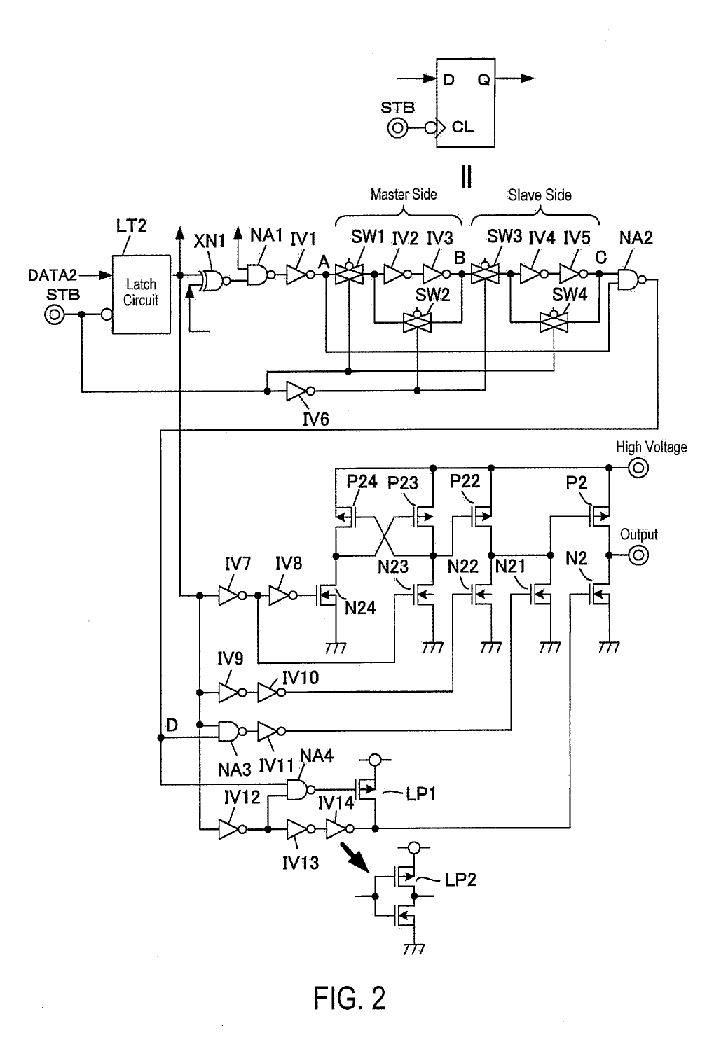

FIG. 2 is a diagram showing a detailed configuration for one output bit circuit in the semiconductor integrated circuit of the embodiment shown in FIG. 1. Specifically, the diagram shows the configuration of the output bit circuit for output 2 shown in FIG. 1. The other output bit circuits have similar configurations.

When DATA2 for determining the state of output 2 is transferred from a shift register (not shown) to the latch circuit LT2, DATA2 is latched in the latch circuit LT2 by the STB signal. XN1 and NA1 designate an exclusive NOR gate and a NAND gate, respectively, forming the first comparator circuit included in the comparator circuit CP2 shown in FIG. 1. The output data from the latch circuit LT2 and the output data from the adjacent latch circuit LT3 are inputted to the exclusive NOR gate XN1. Moreover, the output from the exclusive NOR gate XN1 in this output bit circuit for output 2 and the output from the exclusive NOR gate in the other adjacent output bit circuit for output 1 are inputted to the NAND gate NA1. This makes it possible to detect the case in which its own output bit circuit and adjacent output bit circuits on either side have data in the same states. Moreover, only when the states of the outputs of its own output bit circuit and one of the adjacent output bit circuits on either side are continuously mutually the same, the P-channel transistor (FET) P1 and the N-channel transistor (FET) N2 are controlled to reduce their current capacities.

The output of the NAND gate NA1 (the result of detection of the output states) is inputted to a storage circuit using a D-type flip-flop through an inverter IV1. The storage circuit is formed of switches SW1 to SW4, each turned ON by an H level signal and turned OFF by an L level signal, and inverters IV2 to IV 6, and is divided into a master side and a slave side. The input to and the output from the storage circuit are inputted to NAND gate NA2 forming the second comparator circuit included in the comparator circuit CP2. The output of NAND gate NA2 is used as a signal for changing the current capacities of transistors (FETs) provided at the previous stage of the high breakdown voltage transistors P2 and N2 for changing their respective gate potentials by charging or discharging their gate capacitances. This makes it possible to control the rising speed (time) and the falling speed (time) of the output so as to make the speeds (times) slow (long) only when the lightest capacitive load is presented.

In the circuit shown in FIG. 2, a buffer circuit is formed of inverters IV7 to IV14, NAND gates NA3 and NA4, and P-channel transistor (FET) LP1. Moreover, an inverter circuit and a level shift circuit for the high breakdown voltage section are formed of P-channel transistors (FETs) P22 to P24 and N-channel transistors (FETs) N21 to N24.

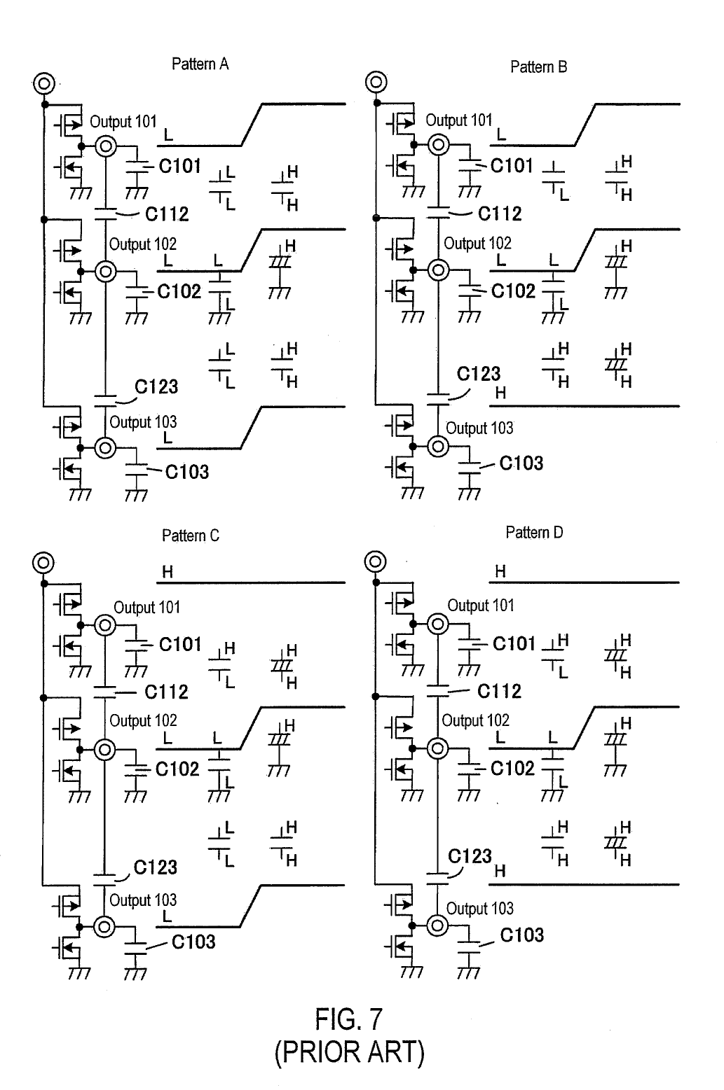

Here, the lightest state of the load becomes the main problem in reducing electromagnetic noise. This is the case when the output of its own output bit circuit and the outputs of the adjacent output bit circuits on either side make their transitions simultaneously with their output states kept mutually the same as in the case shown as the pattern A in FIG. 7. In the worst case, the outputs of all of the output bit circuits (hundreds of output bit circuits per one IC, i.e. 3000 output bit circuits or more per panel) make their transitions simultaneously with their output states kept mutually the same. In this case, each of the outputs has a waveform with considerably fast rising and falling times, and outputs with such waveforms are simultaneously generated in all of the output bit circuits. Conversely, in the states such as those in the cases shown as the patterns B, C and D shown in FIG. 7, the loads are heavier to some extent. Further, in the output state in which the outputs of all of the output bit circuits simultaneously make their respective transitions with their output states different from one another, the electromagnetic noise generated is not larger than that of pattern A. Therefore, in this preferred embodiment, the output bit circuit is formed so as to detect only the state in which the output states of three output bit circuits, namely one output bit circuit and two adjacent output bit circuits on either side, are mutually the same and the same output states occur continuously as in the case shown as pattern A in FIG. 7 (the cases of LLL to HHH, HHH to HHH and HHH to LLL, where sign H represents the output state at the H level and sign L represents the state at the L level). Furthermore, for the output bit circuit in which the above state is detected, an output stage transistor is controlled so that the charging or discharging current of the gate capacitance of the transistor is reduced to increase the rise time or the fall time of the gate voltage so as to slow down the rising or the falling time of the output.

One address driver IC is usually provided with only hundreds of output bit circuits. Therefore, for a panel having 3000 output bit circuits or more as described above, a plurality of ICs are required. Of the output bit circuits in one IC, each of two output bit circuits respectively positioned at both ends of the arranged output bit circuits has only one adjacent output bit circuit. In such an output bit circuit, only the data of the one adjacent output bit circuit can be obtained. For example, in FIG. 1, when the output bit circuit corresponding to output 1 is its own output bit circuit, the only adjacent output bit circuit is the output bit circuit corresponding to output 2 in the IC. The other adjacent output bit circuit is presented in another IC. It is therefore difficult to exchange data with another IC. Since no data of the other adjacent output bit circuit can be obtained, the output bit circuit at the end is made to have a circuit configuration different from that of output bit circuits having adjacent output bit circuits on both sides.

For example, the output bit circuit positioned at the end in this way is formed so that no control according to the invention is carried out upon the output transistor even when the load becomes lightest. The number of such output bit circuits is not more than several tens in one panel. Hence, electromagnetic noise generated there is small compared with the magnitude of the outputs in the whole panel, so that no problem is caused. In the output bit circuit positioned at the upper end in FIG. 1 and corresponding to output 1, although one of the two inputs to the NAND gate NA1 in the first comparator circuit shown in FIG. 2 is connected to the output of the exclusive NOR gate XN1, the other input is grounded. This makes the output of the NAND gate NA1 always remain at the H level regardless of the level of the output from the exclusive NOR gate XN1. In the output bit circuit positioned at the other end opposite to the output bit circuit corresponding to output 1 in FIG. 1, although one of the two inputs to the exclusive NOR gate XN1 in the first comparator circuit shown in FIG. 2 is connected to the output of the latch circuit in its own output bit circuit, the other input is also connected to the output of the latch circuit of its own output bit circuit through an inverter circuit. The inverter circuit can be of the same configuration as that of IV1. Thus, the levels of the two inputs to the exclusive NOR gate XN1 are always made opposite to each other to cause the level of the output of the exclusive NOR gate XN1 to be always at the L level. The output at the L level is inputted to the NAND gate NA1 as one of two inputs. This makes the level of the output of the NAND gate NA1 always remain at the H level regardless of the level of the other input. Thus, in each of the output bit circuits at either end of the IC, the level of the output of the inverter circuit IV1 connected to the NAND gate NA1 in the first comparator circuit never goes to the H level. As will be explained later, in output bit circuits that are not at the end, the level of the output of the inverter circuit IV1 (the level at the point A) is at the H level when the load is lightest. Therefore, in each of the output bit circuits at either end, no control of the output transistor is to be carried out.

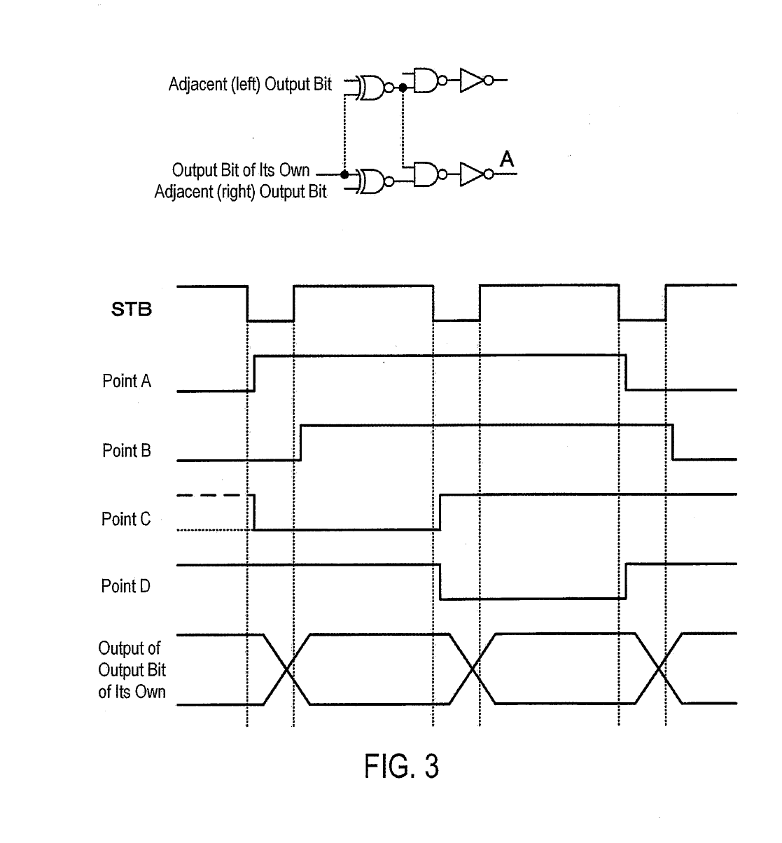

FIG. 3 is a diagram showing the operation of the semiconductor integrated circuit according to the preferred embodiment with output waveforms at specified points in the circuit. The diagram shows respective output waveforms at points A to D shown in FIG. 2 together with the waveforms of the STB signal and the output of its own output bit circuit. The upper section in FIG. 3 shows the state of connections to the adjacent output bit circuits on both sides. Point A is brought to the H level only when all of the data of its own output bit circuit and the adjacent output bit circuits on either side agree with one another, where the three data agree with their states at the H level or at the L level. In the initial state, point A is to be brought to the L level representing disagreement of the data.

Referring to FIG. 3 together with FIG. 2, when the level of the STB signal is at the H level, the switch SW1 is turned ON, while the switch SW2 is turned OFF, so that the level at point B is made equal to that at point A. Moreover, the switch SW3 is turned OFF and the switch SW4 is turned ON, so that the state at point C is brought to the state of outputting the result of the comparison made about data of one step before in the first comparator circuit. The output at point C is inputted together with the output at point A, the result of the comparison of the present data, to the NAND gate NA2 forming the second comparator circuit. The level of the output of the NAND gate NA2, which is the level at point D, becomes the L level only when both of the levels of point A and point B are at the H level. However, because point A is at the L level, the level at point D goes to the H level regardless of the level at point C. In this state, transistors N21 and LP1 are operated together with transistors N22 and LP2.

Next, with the STB signal falling to the L level, the switch SW1 is turned OFF and the switch SW2 is turned ON. Moreover, the switch SW3 is turned ON and the switch SW4 is turned OFF. This maintains the states at point A and point B immediately before the falling of the STB signal, which states were at the L level. Therefore, a signal at the L level is outputted at point C, which allows the state at point D to remain at the H level. Moreover, when the STB signal falls to the L level, new data from the shift register is inputted to the latch circuit LT2 and outputted therefrom. However, until the outputted data reaches point A, switch SW1 is kept turned OFF.

Here, letting the new data agree in its own output bit circuit and in the adjacent output bit circuits on either side, the level at point A goes to the H level. However, at point C, the L level is maintained, which is the result of the comparison of the data of one step before. This makes point D remain at the H level.

Following this, with the level of the STB signal rising to the H level, switch SW1 is turned ON and the switch SW2 is turned OFF to bring the level at point B equal to the level at point A, which is at the H level. However, switch SW3 is turned OFF and the switch SW4 is turned ON. This makes point C continue to output the same data at the L level, the same level as that of the data at present. Furthermore, when the STB signal falls to the L level again, switch SW1 is turned OFF and switch SW2 is turned ON. Moreover, switch SW3 is turned ON and switch SW4 is turned OFF. Therefore, the level at point C becomes equal to the level of point B, which is the H level. Thus, a signal at the H level is outputted from point C.

Simultaneously with this, data in the shift register is newly inputted to the latch circuit LT2 again to be outputted to the first comparator circuit. Then, data as a result of comparison between the outputs of its own output bit circuit and the adjacent output bit circuits on either side is transmitted to point A. When the data as the result of the comparison is at the H level indicating that all of the data inputted agree in their levels, both the levels at point C and at point A at that time are brought to the same H level for the first time. This makes the output of NAND gate NA2 as the second comparator circuit go to the L level to bring point D to the L level. This makes the output of each of the NAND gates NA3 and NA4 go to the H level regardless of the level of the other input. The output from NAND gate NA3 at the L level is inverted into the output at the L level through inverter IV11 before being inputted to the gate of transistor N21, while the output at the H level from NAND gate NA4 is directly inputted to the gate of transistor LP1. Thus, both of transistors N21 and LP1 are brought into turned OFF states. At this time, with the output of the latch circuit LT2 being at the H level, only transistor N22 is to be turned ON. Thus, with the current capacity of transistor N22 being reduced, the speed of discharging the gate capacity of transistor P2 through transistor N22 is slowed down to cause the falling speed of the gate voltage of transistor P2 to be slow, so that the speed of turning ON transistor P2 is reduced to allow the rising speed of the output to become slow, while with the output of the latch circuit LT2 being at the L level at this time, only transistor LP2 is to be turned ON. Thus, with the current capacity of transistor LP2 being reduced, the speed of charging the gate capacity of transistor N2 through transistor LP2 is reduced to cause the rising speed of the gate voltage of transistor N2 to be slow, so that the speed of turning ON transistor N2 is reduced to allow the falling speed of the output to be reduced.

When the load is heavy, transistors N21 and N22 are operated together in parallel to charge or discharge the gate capacity of transistor P2 at the latter stage with a current capacity being the sum of the individual current capacities of transistors N21 and N22. Similarly, transistors LP1 and the LP2 are also operated together in parallel to charge or discharge the gate capacity of transistor N2 at the latter stage with a current capacity being the sum of the individual current capacities of transistors LP1 and LP2. Thus, with the current capacity of each of transistors N21 and LP1 made a little larger than the current capacity of each of transistors N22 and LP2, the rising and the falling of the output can be carried out at increased speeds to some extent.

In the case when the data to its own output bit circuit and the adjacent output bit circuits on either side agree with their levels being unchanged, i.e. brought from the L level to the L level or from the H level to the H level, point D is brought to the L level. Thus, the level of the output of each of the NAND gates NA3 and NA4 connected to point D is at the H level regardless of the level of the other input. This turns OFF transistors N21 and LP1. In this case, however, since no data are changed in their level, with the data being at the H level, the level of the gate of transistor N22 is at the H level, such that, even though transistor N21 is turned OFF, transistor N22 is left to be turned ON to cause no problem. This makes transistor P2 at the latter stage turned ON, so that the level of the output (output 2) is kept at the H level. Moreover, with the data being at the L level, although transistor N22 is turned OFF, the data inputted to inverter IV12 is outputted through inverter IV14 as the data at the L level to turn ON transistor LP2 forming the inverter IV14. Therefore, even though transistor LP1 is turned OFF, transistor LP2 is left to be turned ON. This makes transistor N2 at the latter stage turned ON, which hardly affects the L level of the output (output 2) and causes no problem.

In this way, in the semiconductor integrated circuit according to the preferred embodiment, when the circuit detects that the states of the outputs of its own output bit circuit and the two output bit circuits adjacent thereto are continuously mutually the same, the rise or fall in the output by the output stage transistors at the is controlled. Therefore, generation of electromagnetic noise can be reduced using a simple arrangement.

While the present invention has been particularly shown and described with reference to preferred embodiments thereof, it will be understood by those skilled in the art that the foregoing and other changes in form and details can be made therein without departing from the spirit and scope of the present invention.

What is claimed is:

1. A semiconductor integrated circuit provided with a plurality of output bit circuits connected to respective loads, each output bit circuit comprising:
an output terminal connected to the load;
an output stage transistor, the transistor being connected to the output terminal and configured to be controlled by data inputted to the output bit circuit;
a latch circuit configured to receive the data inputted to the output bit circuit;
a first comparator circuit configured to carry out a first comparison between a state of an output of the latch circuit for the output bit circuit and states of outputs of adjacent latch circuits for other output bit circuits on either side of the output bit circuit in adjacent rows;
a storage circuit configured to hold a first result of the first comparison; and
a second comparator circuit configured to carry out a second comparison between the first result of the first comparison, held by the storage circuit, and a second result of the first comparison, carried out by the first comparator circuit for next inputted data; and
an output waveform modifying device configured to modify at least one of a rising and a falling in an output of the output stage transistor, responsive to a result of the second comparison indicating a match.

2. The semiconductor integrated circuit as claimed in claim 1, wherein the first comparator circuit comprises an exclusive NOR gate and a NAND gate, the storage circuit includes a D-type flip-flop and the second comparator circuit includes a NAND gate.

3. The semiconductor integrated circuit as claimed in claim 1, wherein the output waveform modifying device is a current limiting device.

4. The semiconductor integrated circuit as claimed in claim 3, wherein the current limiting device is configured to change a gate potential of the output stage transistor.

5. The semiconductor integrated circuit as claimed in claim 1, wherein the output waveform modifying device is configured to reduce a rate of the rising or the falling respectively, responsive to a result of the second comparison indicating a match.

6. A method for controlling a semiconductor integrated circuit provided with a plurality of output bit circuits connected to respective loads, the method comprising, for each output bit circuit, the steps of:
providing an output stage transistor controlled by data inputted to the output bit circuit;
receiving the data inputted to the output bit circuit in a latch circuit;
comparing, in a first comparing step, a state of an output of the latch circuit for the output bit circuit with states of outputs of adjacent latch circuits for other output bit circuits on either side of the output bit circuit in adjacent rows;
storing a first result of the first comparing step;
comparing, in a second comparing step, the first result of the first comparing step with a second result of the first comparing step for next inputted data; and
modifying at least one of a rising and a falling in an output of the output stage transistor, responsive to a result of the second comparing step indicating a match.

7. The method as claimed in claim 6, wherein the step of modifying the at least one of the rising and the falling in the output of the output stage transistor further comprises limiting a current capacity of the output stage transistor.

8. The method as claimed in claim 7, wherein the step of limiting a current capacity of the output stage transistor further comprises changing a gate potential of the output stage transistor.

9. The method as claimed in claim 6, wherein the step of modifying the at least one of the rising and the falling in the output of the output stage transistor further comprises reducing a rate of the rising or the falling respectively.
